(19) United States
(12) Patent Application Publication
(10) Pub. No.: US 2011/0181131 A1
(43) Pub. Date: Jul. 28, 2011

(54) FLAT VIBRATING MOTOR

(76) Inventor: Yong-Hua PU, Shenzhen (CN)

(21) Appl. No.: 12/978,567

(22) Filed: Dec. 26, 2010

(30) Foreign Application Priority Data
Jan. 25, 2010 (CN) 201020103774.4

(51) Int. Cl. H02K 33/06

(52) U.S. Cl. 310/28

(57) ABSTRACT

A flat vibrating motor is disclosed. The flat vibrating motor includes a housing having a base and a cover, a magnet assembly suspended inside the housing, and a coil positioned right below the magnet assembly. A magnetic conductive plate is located between the coil and the base.

### FIELD OF THE INVENTION

The present invention generally relates to the art of vibrators and, more particularly, to a flat vibrating motor for generating tactile sensation.

### DESCRIPTION OF RELATED ARTS

Consumer products, such as mobile phones and portable multi-media players, generally include vibrators for generating tactile feedback. For example, a mobile phone has a vibrator for generating vibration while a call is called in, and a portable multi-media player has a touch screen having vibrators for getting tactile feedback.

Generally, the flat vibrating motor comprises a cover, a base forming a receiving cavity together with the cover, a coil located on the base, an elastic member coupled to the base, and a vibrating unit suspended in the receiving cavity by the elastic member. The vibrating unit typically includes a magnet and a weight attached to the magnet. The coil is positioned right below the magnet.

In order to increase vibration amplitude of the flat vibrating motor, height of the coil or magnetic degree of the magnet is accordingly designed to be increased. However, increasing of the height of the coil or magnetic degree of the magnet will make the volume of the motor increased. So, it is necessary to provide a new vibrator for solving the problem mentioned above.

### BRIEF DESCRIPTION OF THE DRAWINGS

FIG. 1 is an isometric view of a flat vibrating motor in accordance with an exemplary embodiment of the present invention;

FIG. 2 is a top view of the flat vibrating motor in FIG. 1, a cover thereof being removed; and

FIG. 3 is a cross-sectional view of the flat vibrating motor in FIG. 1.

### DETAILED DESCRIPTION OF THE EXEMPLARY EMBODIMENT

Reference will now be made to describe an exemplary embodiment of the present invention in detail.

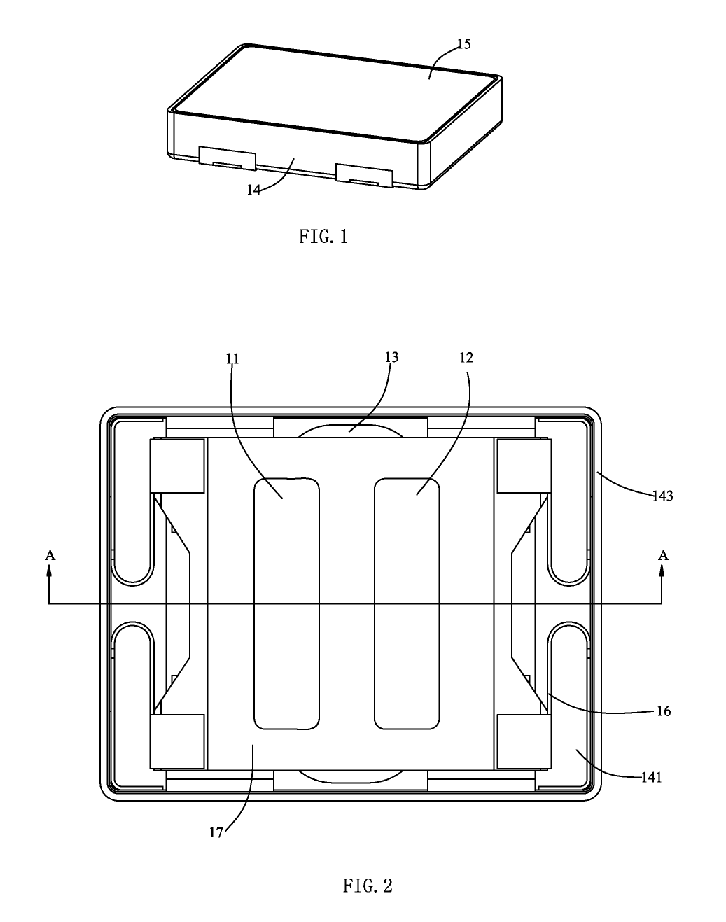

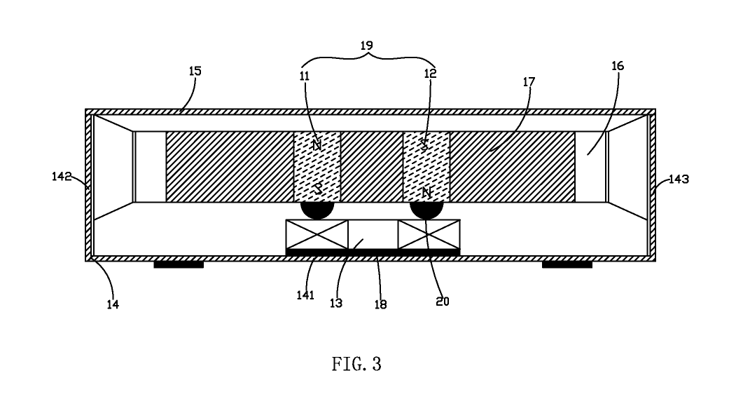

Generally, a flat vibrating motor is mounted on a printed circuit board of an electronic device, such as a mobile phone, for generating tactile vibration. Referring to FIGS. 1-3, a flat vibrating motor, in accordance with the exemplary embodiment of the present invention, includes a cover 15, and a base 14 forming a receiving space together with the cover 15. The cover 15 and the base 14 corporately form a housing having the receiving space. The housing accommodates an annular coil 13, a plurality of elastic members 16, a weight 17, and a magnet assembly 19 in the receiving space.

The base 14 further defines a bottom wall 141 and a plurality of sidewalls 142 extending vertically from the bottom wall 141. The magnet assembly 19 is at least partially received in the weight 17, and the combination of the weight 17 and the magnet assembly 19 is served as a moving unit. In fact, the weight 17 is used to enhance the vibrating amplitude of the moving unit. A sole magnet assembly without the weight can also be regarded as a moving unit. While assembled, the coil 13 is located right below the magnet assembly 19. Each of the elastic members 16 is received in the receiving space with one end positioned on the sidewall 142 of the base 14 and a spring arm connected to the moving unit. Thus, the moving unit is suspended in the receiving space by the elastic members 16. When electrified, the moving unit vibrates along a direction paralleled to the bottom wall 141 of the base 14. In the exemplary embodiment, the elastic members 16 are connected to the weight 17 for suspending the moving unit in the receiving space. However, in fact, when the magnet assembly solely serves as a moving unit, the elastic members 16 can also be directly connected to the magnet assembly, by which the magnet assembly is suspended in the receiving space for being capable of vibrating along the direction parallel to the bottom wall 141 of the base 14.

The weight 17 defines a through hole in a middle portion thereof for receiving the magnet assembly 19 therein. It is illustrated in the exemplary embodiment that the magnet assembly 19 has a first magnet part 11 and a second magnet part 12, and the through hole of the weight 17 includes a first hole and a second hole for receiving the first and second magnet parts, respectively. The first magnet part 11 has magnetic poles opposite to those of the second magnet part 12, as shown in FIG. 3. Planes of magnetic poles of the magnet assembly 16 are parallel and face to the bottom wall 141 and are also parallel to the coil 13. Thus, the magnet assembly 19, together with the weight 17, is suspended in the receiving space by the elastic members 16. The annular coil 13 being located right below the first magnet part 11 and the second magnet part 12. For reducing magnetic flux leakage and increasing the magnetic flux through the coil, a magnetic conductive plate 18 is located between the coil 13 and the bottom wall 141. The magnetic conductive plate 18 defines a top surface parallel to and abutting against the coil 13, and a lower surface parallel to and abutting against the base 14.

When the coil 13 is electrified, the moving unit is forced to move along a direction parallel to the bottom wall 141 by electro-magnetic force, i.e., the Lorentz force. The coil 13 is positioned on the magnetic conductive plate 18 positioned on the base 14.

The magnetic conductive plate 18 reduces magnetic flux leakage through the coil 13, and effectively strengthens vibration of the flat vibrating motor 1. For widening the band width of responding frequency of the motor, a magnetic fluid 20 is attracted to a bottom of the magnet assembly 19. Friction exists between the magnetic fluid 20 and a top surface of the coil 13 during the vibration of the moving unit.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A flat vibrating motor, comprising:
a cover;
a base forming a housing together with the cover, the base defining a bottom wall;
a magnet assembly suspended in the housing and being capable of vibrating along a direction parallel to the bottom wall of the base;
a number of elastic members suspending the magnet assembly in the housing;
a coil located below the magnet assembly and positioned above the bottom wall of the base;
a magnetic conductive plate positioned between the coil and bottom wall of the base for reducing magnetic flux leakage.

2. The flat vibrating motor as described in claim 1, wherein the magnetic conductive plate defines a top surface parallel to and abutting against the coil and a lower surface parallel to and abutting against the bottom wall of the base.

3. The flat vibrating motor as described in claim 1, wherein the magnet assembly has a first magnet part and a second magnet part separately, and the magnetic poles of first magnet part are opposite to the magnetic poles of second magnet part.

4. The flat vibrating motor as described in claim 1 further comprising a weight defining a through hole for accommodating the magnet assembly therein.

5. The flat vibrating motor as described in claim 1 further comprising a magnetic fluid attracted to a bottom of the magnet assembly for rubbing the coil.

6. A flat vibrating motor, comprising:
a cover;
a base forming a housing together with the cover, the housing forming a receiving space;
a plurality of elastic members accommodated in the receiving space;
a moving unit suspended in the housing by the elastic members;
a magnetic conductive plate positioned on the base; and
a coil located on the magnetic conductive plate and positioned between the moving unit and the magnetic conductive plate.

7. The flat vibrating motor as described in claim 6 further comprising a magnetic fluid located between a bottom of the moving unit and a top of the coil, and friction exists between the magnetic fluid and the coil.
